(19) United States
(12) Patent Application Publication
(10) Pub. No.: US 2008/0295087 A1
(43) Pub. Date: Nov. 27, 2008

(54) FIRMWARE UPGRADE SYSTEM AND CONTROL METHOD THEREOF

(75) Inventors: Jung Suk KANG, Suwon-si (KR); Dong Ho Shin, Yongin-si (KR); Dong Soo Jun, Seoul (KR); Tae Hee Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/114,177

(22) Filed: May 2, 2008

(30) Foreign Application Priority Data
May 25, 2007 (KR) 2007-50728
Aug. 30, 2007 (KR) 2007-87716

(51) Int. Cl. G06F 9/44

(52) U.S. Cl. 717/168

(57) ABSTRACT

A firmware upgrade system searches for and upgrades to a new version of firmware without a user's attendance. The firmware upgrade system includes a user terminal to generate a search command signal while unattended by the user to initiate a search for a new version of electric appliance firmware, and a server to determine whether the new version of electric appliance firmware is present in response to the search command signal. The new version of electric appliance firmware, if present on the server, is transmitted to the user terminal and replaces the firmware in firmware storage if the new version of firmware is more recent than the firmware in firmware storage.

### CROSS-REFERENCE TO RELATED APPLICATIONS

This application claims the benefit of Korean Patent Application No. 2007-0050728, filed on May 25, 2007 in the Korean Intellectual Property Office and No. 2007-0087716, filed on Aug. 30, 2007 in the Korean Intellectual Property Office, the disclosure of which is incorporated herein in its entirety by reference.

### BACKGROUND OF THE INVENTION

1. Field of the Invention

The present general inventive concept relates to a firmware upgrade system, and, more particularly, to a firmware upgrade system which is capable of searching for a new version of firmware without a user initiating the search, upgrading to the new version of firmware located by the search, and a control method thereof.

2. Description of the Related Art

In general, firmware refers to a hardware control micro-program stored in an erasable programmable read only memory (EPROM). The firmware is software in that it is a defined by program code, but is different from general application software in that it is closely related to hardware. In this regard, the firmware can be considered to have both software and hardware characteristics.

Consider hardware that performs a certain function is constructed and that the function is implemented by only hardware. In such configuration, the control structure is very complicated and carrying out certain logical expressions in hardware is often difficult.

The foregoing problem is solved very simply and with low cost by replacing a large portion of the control structure with software and configuring a storage unit having the software stored therein accessible to a hardware control circuit. This software that replaces hardware control functions is referred to as firmware.

As time passes, firmware often must be upgraded to a new version to improve the function or performance of an electric appliance using the firmware. As used herein, an “electric appliance” is any electrical device that is controlled through one or more control functions, such as that which may be implemented in firmware.

In order to upgrade the firmware, conventionally, a connection is made to a Web site from which a new version of firmware can be downloaded. The Web site is searched for the new version of firmware, and the firmware that is found by the search is downloaded from the Web site to a memory. Then, the new version of firmware downloaded to the memory is encoded on a recording medium (for example, a compact disc (CD) or digital versatile disc (DVD)), and the encoded recording medium is decoded by a media reader in an electric appliance to upgrade firmware that is stored in the electric appliance to the new version of firmware.

However, such a conventional firmware upgrade method has a disadvantage in that the user must connect to the Web site and personally search for the new version of firmware.

Therefore, in order to solve such problems and provide the user with greater convenience, there is a need to search for and upgrade to a new version of firmware without the inconvenience and errors associated with doing so by an operator who may not possess the technical skills to perform a firmware upgrade.

### SUMMARY OF THE INVENTION

Therefore, the present general inventive concept provides a firmware upgrade system to search for a new version of firmware without user initiation thereof, to upgrade stored firmware to the new version thereof, and a control method of a firmware upgrade system.

Additional aspects and/or advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a firmware upgrade system including a user terminal to generate, unattended by a user, a search command signal to initiate a search for a new version of electric appliance firmware, and a server to determine whether the new version of electric appliance firmware is present thereon, in response to the search command signal, and to transmit the new version of electric appliance firmware, if present on the server, to the user terminal.

The user terminal may include a runner to execute a management program to upgrade the firmware of the electric appliance, and a controller to generate the search command signal in response to the management program and to transmit detailed information to the server regarding the firmware with the search command signal.

The user terminal may further include a receiver to receive the new version of electric appliance firmware from the server, and a storage unit to store the received electric appliance firmware.

The user terminal may further include a recorder to record the stored electric appliance firmware on a recording medium.

The user terminal may further include an output unit to output a confirmation message to confirm a user intent to upgrade the firmware to the new version thereof received from the server, and a user interface to receive a user input that confirms or denies the intent to upgrade the firmware.

The user terminal may further include a checker to determine whether the recording medium has been provided the user terminal. The output unit may output a selection message as to whether to record the new version of electric appliance firmware on the recording medium.

The recorder may create a firmware directory on the recording medium and may record the new version of electric appliance firmware in the created directory.

The firmware upgrade system may further include a recording medium reader at the electric appliance to read the recording medium on which the new version of electric appliance firmware has been recorded.

The electric appliance may include a firmware storage unit at the electric appliance in which the firmware is stored, a controller at the electric appliance to compare the new version of electric appliance firmware recorded on the recording medium with the electric appliance firmware stored in the firmware storage unit, and an output unit to output a selection message to confirm a user intent to upgrade the firmware to the new version thereof when the new version of electric appliance firmware is newer than the electric appliance firmware stored in the firmware storage unit.

The foregoing and/or other aspects and utilities of the present general inventive concept may also be achieved by providing a firmware upgrade system including an electric appliance to generate unattended by a user a search command signal to initiate a search for a new version of firmware of the electric appliance, and a server to conduct the search for the new version of the firmware in response to the search command signal and to transmit the new version of the firmware to the electric appliance if the new version of the firmware is located by the search.

The electric appliance may include a runner to execute a management program to upgrade the firmware of the electric appliance, and a controller to generate the search command signal responsive to the management program and to transmit detailed information of the firmware to the server with the search command signal.

The electric appliance may further include a receiver to receive the new version of the firmware from the server, a storage unit to store the received firmware, and a recorder to record the stored firmware on a recording medium.

The electric appliance may further include a user interface to display a confirmation message indicating that the new version of the firmware is received.

The electric appliance may further include a checker to determine whether the recording medium having the new version of the firmware recorded thereon has been provided to the electric appliance. The controller, if the recording medium is provided, may compare the new version of the firmware recorded on the recording medium with the firmware stored in firmware storage of the electric appliance, and may upgrade the stored firmware to the new version thereof when the new version of the firmware is more recent than the firmware in the firmware storage.

The foregoing and/or other aspects and utilities of the present general inventive concept may also be achieved by providing a control method of a firmware upgrade system generating at a first location unattended by a user a search command signal to initiate a search for a new version of electric appliance firmware, transmitting the search command signal from the first location unattended by the user to a second location at which to perform the search, performing the search at the second location to determine whether the new version of electric appliance firmware is located thereat in response to the search command signal, and transmitting the new version of electric appliance firmware to the first location if the new version of electric appliance firmware is located by the search at the second location.

The new version of electric appliance firmware may be received and stored at the first location, and may be recorded on a recording medium.

The control method may further include reading the recording medium to upgrade electric appliance firmware stored in the firmware storage of the electric appliance to the new version of electric appliance firmware.

A confirmation message may be displayed indicating that the new version of electric appliance firmware is received at the first location.

The control method may further include determining whether the recording medium has been provided in a recorder, and displaying a selection message to determine whether to record the new version of electric appliance firmware on the recording medium.

The control method may further include creating a firmware directory on the recording medium in which to record the stored electric appliance firmware, and recording the new version of electric appliance firmware in the created directory.

The control method may further include comparing the new version of electric appliance firmware recorded on the recording medium with the electric appliance firmware stored in the firmware storage, and displaying a selection message to determine whether to upgrade to the new version of electric appliance firmware when the new version of electric appliance firmware is more recent than the electric appliance firmware in the firmware storage.

The control method may further include reading the recording medium in an electric appliance separate and distinct from a user terminal at the first location at which the new version of the electric appliance firmware is recorded on the recording medium.

The foregoing and/or other aspects and utilities of the present general inventive concept may also be achieved by providing a system to upgrade firmware code of an electric appliance including a firmware storage unit to store the firmware code therein, an upgrade controller to generate a search signal in response to other than a user's initiation thereof that would initiate a search for a new version of the firmware code, a locator to locate the new version of the firmware code in response to the search signal, and a controller to replace the firmware code in the firmware storage unit with the new version of the firmware code located by the locator.

The foregoing and/or other aspects and utilities of the present general inventive concept may also be achieved by providing a method of upgrading firmware code of an electric appliance that locates a new version of the firmware code in response to a search signal generated by other than user activation thereof, and replaces the firmware code in a firmware storage unit with the located new version of the firmware code.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a firmware upgrade system according to one embodiment of the present general inventive concept;

FIG. 2 is a block diagram of a firmware upgrade system according to an alternative embodiment of the present general inventive concept; and

FIG. 3 is a flowchart illustrating a control process of a firmware upgrade system according to one embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

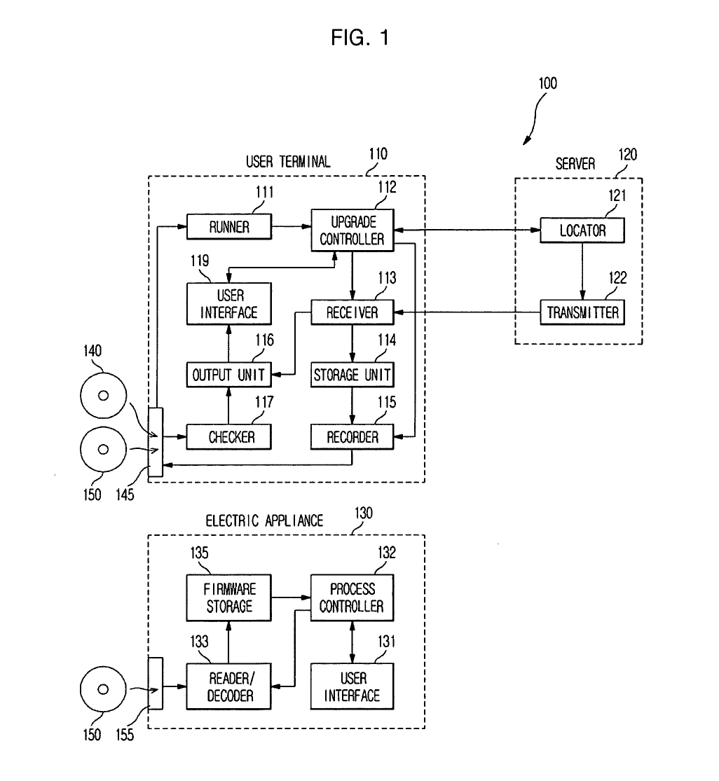

FIG. 1 is a block diagram of an exemplary firmware upgrade system according to one embodiment of the present general inventive concept. As illustrated in FIG. 1, the exemplary firmware upgrade system 100 includes a user terminal 110, a server 120, and an electric appliance 130.

The user terminal 110 may be connected with the server 120 via a network, and may include a runner 111, an upgrade controller 112, a receiver 113, a storage unit 114, a recorder 115, an output unit 116, a checker 117, a user interface 119, and a drive 145.

The runner 111 may install a management program if a recording medium 140 having the management program recorded thereon is inserted in a drive 145 of the user terminal 110. As used herein, the “management program” refers to a machine process that executes a series of operations to upgrade the firmware, such as connecting to a Web site, searching the Web site for a new version of the electric appliance firmware and downloading the found electric appliance firmware from the Web site.

The recording medium 140 having recorded thereon the management program to upgrade the firmware of the electric appliance 130 may be provided with the electric appliance 130 as purchased. When the provided recording medium 140 is inserted in the drive 145 of the user terminal 110, the management program may be installed and stored in the user terminal 110, such as in storage unit 114 or other memory accessible by the runner 111. The management program stored in the user terminal 110 may then be executed by the runner 111 periodically according to a maintenance schedule that is implemented by the management program. For example, the maintenance schedule of the management program may determine if upgraded firmware is available, such as described in the embodiments below, every month, every six months, or any other suitable period of time. The present general inventive concept is not limited by the format or time periods of the maintenance schedule, which may be implemented by, for example, suitable processor instruction coding.

At the time designated by the maintenance schedule, the runner 111 executing the maintenance program may provide a suitably formatted signal to the upgrade controller 112. In response to the signal from the runner 111, the upgrade controller may transmit a search command signal to the server 120 to initiate a search for a new version of electric appliance firmware. The search command signal from the upgrade controller 112 may include detailed information regarding the firmware, such as by suitable data encoding onto the search command signal, to assist the search facilities of the server 120 in locating the applicable firmware upgrade.

The detailed information of the firmware may be used to determine whether a more recent version of firmware is present on the server 120, and may include information such as a serial number of the electric appliance where the firmware is installed, a current version of the firmware, an upload date, a file format, and other data that can be used to identify the applicable firmware. The new version of electric appliance firmware can be understood as a file containing coded instructions that can be executed by a process controller to improve the function or performance of the electric appliance. As used herein, a “new” version of firmware refers to a version that is more recent than the version stored in, and being used by the electric appliance 130. The new version of the firmware may be in the form of a full upgrade version, which replaces the firmware code presently used by the electric appliance 130 in its entirety, or as a patch version of the new electric appliance firmware, which replaces one or more segments of the firmware code being used by the electric appliance 130.

The aforementioned search command signal may be transmitted to the server 120 at predetermined intervals of time (for example, a preset upgrade period according to the maintenance schedule) without user attendance at the user terminal, and without the user initiating the search. The transmission of the search command signal to the server 120 at predetermined intervals of time eliminates the requirement in the conventional firmware upgrade system of the user having to connect to a Web site and manually determine whether a new version of firmware has been released.

The receiver 113 may receive a new version of electric appliance firmware transmitted from the server 120, and the storage unit 114 may store the received new version of the firmware. The storage unit 114 may be a storage medium suitable to store the new version of electric appliance firmware, such as a dynamic random access memory (DRAM), synchronous DRAM (SDRAM), Rambus DRAM (RDRAM), double data RAM (DDRAM) or static RAM (SRAM), as well as other types of storage.

The recorder 115 may record a new version of electric appliance firmware on a recording medium 150. Such recording may be implemented by encoding the firmware code onto the recording medium 150 in a manner suitable therewith. It is to be understood that although the storage medium in FIG. 1 is illustrated as a disk 150 coupled to the drive 145, other storage media may be used by the present general inventive concept without departing from the spirit and intended scope thereof. For example, the recording medium 150 may be implemented by a flash memory device coupled to a Universal Serial Bus (USB) port. Additionally, the recorder 115 may encode processing instructions that, when executed by a controller at the electric appliance, performs any operation necessary to load the new version of the firmware into firmware storage thereat. For example, in addition to the new version of the firmware, the recorder 115 may also encode boot instructions and a loader routine onto the recording medium 150 so that the upgrade can be performed via a reboot of the process controller. Alternatively, the recorder 115 may include an address of a loader routine in the firmware code stored in the firmware storage at the electric appliance 130 which the process controller can execute to perform the upgrade. The present general inventive concept is not limited by the implementation of the firmware upgrade process that replaces the firmware in firmware storage with the new version of the firmware obtained from the server 120.

The recorder 115 may create a separate firmware directory on the recording medium and may store the firmware in the created firmware directory. By recording the firmware in the separate firmware directory in this manner, the new version of electric appliance firmware may be uploaded to the electric appliance 130 in an efficient manner, since the new version of the firmware could be readily located from information regarding the directory, such as a directory name or a directory creation date.

The output unit 116 may format a confirmation message indicating that a new version of electric appliance firmware is received and may provide the formatted message to a user interface 119 of the user terminal 110.

For example, if a new electric appliance firmware version is 2.0, the output unit 116 may format a confirmation message such as “Firmware version 2.0 has been newly introduced to the market. Select Confirm if you would like to upgrade to the new version.” Then, if the user selects a confirm button on the user interface 119 to upgrade to the new version of electric appliance firmware, the output unit 116 may format suitable instruction messages to guide the user to insert a recording medium 150 into the drive 145 of the user terminal 110, and output the instruction messages to the user interface 119. The user interface 119 may be implemented in any suitable manner, such as by a graphical user interface containing user controls activated by the user through one or more human interface devices, such as a keyboard or a mouse. The user interface 119 may include a display capable of outputting the confirmation message, and other messages and graphics, such as a liquid crystal display (LCD), plasma display panel (PDP), thin film transistor (TFT) LCD, organic electroluminescent (EL) display or cathode ray tube (CRT).

The checker 117 may determine whether a recording medium 150 has been inserted in the drive 145 of the user terminal 100. If the recording medium 150 is inserted in the drive 145, the output unit 116 outputs to the user interface 119 a selection message as to whether the user wishes to record the new version of electric appliance firmware on the recording medium 150.

For example, the output unit 116 may format a selection message, such as “Firmware version 2.0 has been newly introduced to the market. Do you want to record the new version on the recording medium to upgrade to the new version?” Then, if the user wants the recording of the new version of firmware, the recorder 115 encodes the new version of electric appliance firmware on the recording medium 150 inserted in the drive 145.

As illustrated in FIG. 1, the server 120 may include a locator 121 and a transmitter 122. The locator 121, when the detailed information of the firmware and the search command signal are received at the server 120 as described above, determines whether a new version of the electric appliance firmware is located thereat, using the received detailed firmware information. The locator 121 of server 120 may internally perform suitable processing operations to locate a new version of the firmware responsive to the search command signal and may transmit a message indicative of the processing results to the user terminal 110, where they may be displayed on the user interface 119.

The transmitter 122, when the new version of electric appliance firmware is located by the locator 121, may transmit the new version of electric appliance firmware to the receiver 113 of the user terminal 110.

When a recording medium 150 is inserted in a drive 135 of the electric appliance 130, the recording medium 150 is read by a recording medium reader, such as described below, to determine whether the contents thereof include the new version of electric appliance firmware.

As illustrated in FIG. 1, in addition to the drive 135, the electric appliance 130 a user interface 131, a process controller 132, a recording medium reader/decoder 133, a firmware storage unit 135, and a drive 155. The process controller 132 may, among other functions to be described below, control the electric appliance 130 according to the firmware code stored in firmware storage unit 132.

In addition to executing the control functions of the electric appliance 130, the process controller 132 may execute processing instructions in the firmware storage unit 135 that perform the upgrade of the firmware. The process controller 132 may compare the new version of electric appliance firmware recorded on the recording medium 150 with electric appliance firmware stored in the firmware storage unit 135. When the new version of electric appliance firmware is more recent than the stored electric appliance firmware, the user interface 131 may display a selection message as to whether to upgrade to the new version of electric appliance firmware.

When the user agrees to upgrade to the new version of firmware by confirming the selection message outputted to the user interface 131, the firmware upgrade may be performed through a data transfer process implemented by a suitable firmware loader routine. In certain embodiments of the present general inventive concept, the controller 132 performs the firmware comparison by checking the firmware in the most recently created firmware directory on the recording medium 150, as determined by the reader/decoder 133. The process controller 132 may, upon a positive determination that the user wishes to upgrade the firmware, direct the reader/decoder 133 to read and decode the data on recording media 150 in drive 155, and to transfer the decoded data at the proper address or addresses in the firmware storage unit 135.

Hereinafter, an alternative embodiment of the firmware upgrade system will be described.

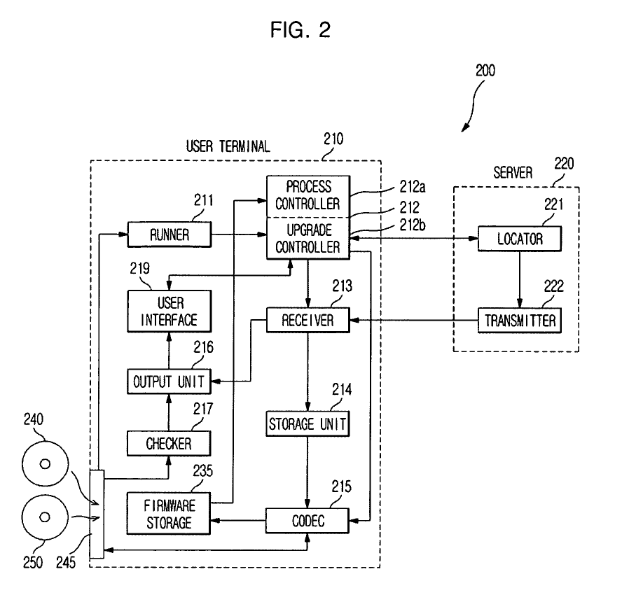

FIG. 2 is a block diagram of an exemplary firmware upgrade system 200 according to an alternative embodiment of the present general inventive concept. As illustrated in FIG. 2, the exemplary firmware upgrade system 200 includes an electric appliance 210 and a server 220.

The electric appliance 210 may be connected with the server 220 via a network, and may include a runner 211, a controller 212, a receiver 213, a storage unit 214, a coder/decoder (codec) 215, an output unit 216, a checker 217, a user interface unit 219, a firmware storage unit 235, and a drive 245. The controller 212 may combine the functions of an upgrade controller 212a, such as described with regard to upgrade controller 112 in FIG. 1, and a process controller 212b, such as described with regard to process controller 132 in FIG. 1. In the descriptions below of the exemplary embodiment in FIG. 2, the controller 212 will be referred to as a single unit, and the process or upgrade functions are to be understood as being implemented in a manner similar to upgrade controller 112 and process controller 132 of FIG. 1.

The runner 211 may install and periodically execute a management program in a manner similar to runner 111 of FIG. 1, if a recording medium 240 having the management program recorded thereon is inserted in the drive 245.

The controller 212 may transmit a search command signal to the server 220 to initiate a search for a new version of electric appliance firmware in response to a signal provided by runner 211. In a manner similar to that described above with reference to FIG. 1, the upgrade signal may be generated by the runner 211 in accordance with a predetermined maintenance schedule. The controller 212 may transmit detailed information regarding the firmware to the server 220 together with the search command signal, where the detailed information may be a serial number of the electric appliance on which the firmware is installed, a current version of the firmware, an upload date, a file format, and other data to indicate a current or request version level of the firmware, or other information that can be used to identify the new version of the firmware. The search command signal may be transmitted to the server 220 at intervals of a predetermined time according to, for example, the maintenance schedule described above, without activation by the user.

The receiver 213 may receive a new version of electric appliance firmware transmitted from the server 220 in a manner similar to that discussed with reference to FIG. 1. The storage unit 214 may store a full version or patch version of the received electric appliance firmware, as discussed above, and may be implemented by a suitable storage medium such as a DRAM, SDRAM, RDRAM, DDRAM or SRAM.

As illustrated in FIG. 2, the electric appliance 210 includes a codec 215 to encode and write data on, and read and decode data from a recording medium 250 inserted into drive 245. The codec 215 may be implemented by any coder/decoder suitable to the type of recording medium and the corresponding type of drive, and the present general inventive concept is not limited by the implementation thereof.

The codec 215 may record a new version of electric appliance firmware on a recording medium 150. In certain embodiments of the present general inventive concept, the codec 215 may create a separate firmware directory in the recording medium 150 and may encode the firmware in the created firmware directory. By recording the firmware in the separate firmware directory in this manner, as discussed above, it is possible to upload the new version of electric appliance firmware to the electric appliance 210 efficiently.

The output unit 216 may format a confirmation message indicating that a new version of electric appliance firmware is received. The output unit 216 may transmit the formatted confirmation message to the user interface 219 where the message can be displayed to the user, if the new electric appliance firmware version is 2.0, the output unit 216 may format a confirmation message such as “Firmware version 2.0 has been newly introduced to the market. Select Confirm if you would like to upgrade to the new version.” The user may then select a confirm button, such as in a graphic user interface, to confirm the user's intent to upgrade to the new version of electric appliance firmware. The output unit 216 may then format messages to guide the user to insert a recording medium 250 into the drive 245, such as described above with reference to FIG. 1.

The checker 217 may determine whether the recording medium 250 has been inserted in the drive 245. If the recording medium 250 is inserted in the drive 245, the output unit 216 may format a selection message to provide to the user interface 219 to determine whether to record the new version of electric appliance firmware on the recording medium 250. For example, the output unit 216 may provide a formatted selection message such as “Firmware version 2.0 has been newly introduced to the market. Do you want to record the new version on the recording medium to upgrade to the new version?” Then, if the user wants a recorded copy of the new firmware version, the codec 215 encodes the new version of electric appliance firmware on the recording medium 250 inserted in the drive 245.

In a manner similar to that described with reference to FIG. 1, the controller 212 may compare the new version of the electric appliance firmware recorded on the recording medium with electric appliance firmware stored in firmware storage 235. When the new version of electric appliance firmware is more recent than the firmware stored in firmware storage 235, the output unit 216 may format a selection message as to whether to upgrade to the new version of electric appliance firmware. When the user agrees to upgrade to the new version of firmware by confirming the selection message through the user interface 219, the controller 212 may replace the electric appliance firmware in the firmware storage 235 with the new version of electric appliance firmware.

Alternatively, in certain embodiments of the present general inventive concept, when the new version of electric appliance firmware recorded on the recording medium is newer than the preset electric appliance firmware, the electric appliance firmware stored in firmware storage 235 may be upgraded to the new version of electric appliance firmware without requiring the user confirmation to do so. In another embodiment of the present general inventive concept, the firmware in firmware storage 235 may be upgraded from the firmware stored in the storage unit 214 without storing the upgraded firmware on the recording medium 250. For example, the storage unit 214 may be implemented by non-volatile memory, such as flash memory. The firmware upgrade system 200 may bypass the selection message and the confirmation message described above, and the corresponding user selection and user confirmation, and may upgrade the firmware in firmware storage 235 with the firmware in storage unit 214 if the user has, for example, selected an option through the user interface 219 to allow such operation.

The server 220 may include a locator 221, and a transmitter 222, each of which may operate in a manner similar to locator 121 and transmitter 122, respectively, described with reference to FIG. 1.

Hereinafter, an exemplary control process of the firmware upgrade system 100 and 200 will be described.

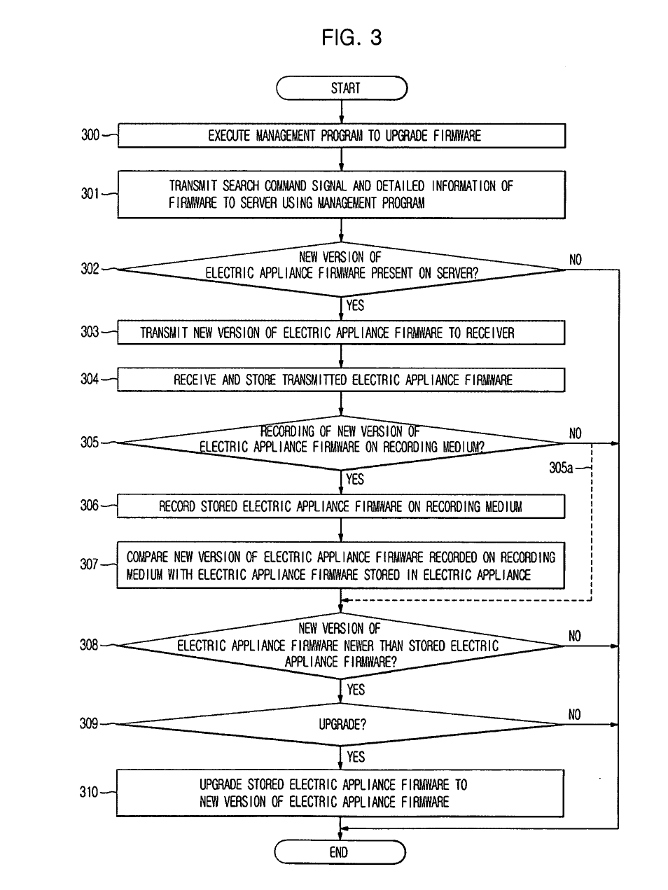

FIG. 3 is a flowchart illustrating an exemplary control process of a firmware upgrade system according to an embodiment of the present general inventive concept. Referring to exemplary process illustrated in FIG. 3, a management program is executed to upgrade firmware (operation 300). As stated above, the management program may be executed periodically to determine whether a more recent version of firmware is available than is in use by the electrical appliance 110, 210.

The management program executes operations at the user terminal including transmitting a search command signal to a server to determine whether a new version of electric appliance firmware is available thereat. The search command signal may have encoded thereon detailed information of the firmware (operation 301). Once the detailed firmware information and the search command signal are received at the server, the server determines whether the new version of electric appliance firmware is present (operation 302).

Upon a positive determination that the new version of electric appliance firmware is present, the server transmits the new version of electric appliance firmware to the receiver in the user terminal 110 or the electrical appliance 210 (operation 303). The receiver receives and stores the transmitted electric appliance firmware (operation 304).

Once the new version of electric appliance firmware is received, it is determined whether to record the new version of electric appliance firmware on a recording medium (operation 305).

In order to determine whether to record the new version of electric appliance firmware, a selection message may be displayed as to whether to record the new version of electric appliance firmware and the user may personally select whether to record the new version of electric appliance firmware.

If the user selects to record the new version of electric appliance firmware on the recording medium in operation 305, the user terminal records the stored electric appliance firmware on the recording medium (operation 306). Alternatively, the recording operation 306 may be bypassed, as indicated by flow line 305a, such as when the upgrade is made from the storage unit 214 rather than the recording medium 250.

As stated above, in certain embodiments of the present general inventive concept, a firmware directory may be created on the recording medium in which the new version of electric appliance firmware is stored.

Upon the recording medium being inserted into an electric appliance after the new version of electric appliance firmware is recorded on the recording medium in the above-described manner, the electric appliance reads the recording medium and compares the new version of electric appliance firmware recorded on the recording medium with electric appliance firmware stored in firmware storage (operation 307) to determine whether the new version of electric appliance firmware recorded on the recording medium is of a more recent version than the stored electric appliance firmware (operation 308).

When it is determined in operation 308 that the new version of electric appliance firmware recorded on the recording medium is more recent than the stored electric appliance firmware, it is determined whether the user wants to upgrade to the new version of electric appliance firmware (operation 309). If the user wants to upgrade, the firmware in the electric appliance firmware is upgraded to the new version of electric appliance firmware (operation 310) as described above.

As an alternative, in certain embodiments of the present general inventive when the new version of electric appliance firmware recorded on the recording medium is more recent than the preset electric appliance firmware, the preset electric appliance firmware may be upgraded to the new version of electric appliance firmware without other user intervention, e.g., without responding to a selection message as to whether to upgrade to the new version of electric appliance firmware.

As is apparent from the above description, according to the firmware upgrade system and control method thereof of the present general inventive concept, the user terminal or electric appliance can periodically connect to the server through the management program provided with the electric appliance to search for a new version of firmware without the user having to initiate or perform the search. Therefore, it is possible to perform the firmware upgrade efficiently and with a lesser likelihood of user error.

The present general inventive concept further provides greater user convenience.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A firmware upgrade system comprising:
a user terminal to generate unattended by a user thereof a search command signal to initiate a search for a new version of firmware of an electric appliance; and
a server to determine whether the new version of electric appliance firmware is present thereon, in response to the search command signal, and to transmit the new version of electric appliance firmware, if present thereon, to the user terminal.

2. The firmware upgrade system according to claim 1, wherein the user terminal comprises:
a runner to execute a management program to upgrade the firmware of the electric appliance; and
a controller to generate the search command signal in response to the management program, and to transmit detailed information to the server regarding the firmware with the search command signal.

3. The firmware upgrade system according to claim 2, wherein the user terminal further comprises:
a receiver to receive the new version of electric appliance firmware from the server; and
a storage unit to store the received electric appliance firmware.

4. The firmware upgrade system according to claim 3, wherein the user terminal further comprises:
a recorder to record the stored electric appliance firmware on a recording medium.

5. The firmware upgrade system according to claim 4, wherein the user terminal further comprises:
an output unit to output a confirmation message to confirm a user intent to upgrade the firmware to the new version thereof received from the server; and
a user interface to receive a user input that confirms or denies the intent to upgrade the firmware.

6. The firmware upgrade system according to claim 5, wherein the user terminal further comprises:
a checker to determine whether the recording medium has been provided at the user terminal,
wherein the output unit outputs a selection message as to whether to record the new version of electric appliance firmware on the recording medium.

7. The firmware upgrade system according to claim 4, wherein the recorder creates a firmware directory on the recording medium and stores the new version of electric appliance firmware in the created directory.

8. The firmware upgrade system according to claim 4, further comprising:
a recording medium reader at the electric appliance to read the recording medium on which the new version of electric appliance firmware is recorded.

9. The firmware upgrade system according to claim 8, further comprising:
a firmware storage unit at the electric appliance in which electric appliance firmware is stored;
a controller at the electric appliance to compare the new version of electric appliance firmware recorded on the recording medium with the electric appliance firmware stored in the firmware storage; and
an output unit to output a selection message to confirm a user intent to upgrade the firmware to the new version thereof when the new version of electric appliance firmware is newer than the electric appliance firmware stored in the firmware storage unit.

10. A firmware upgrade system comprising:
an electric appliance to generate unattended by a user thereof a search command signal to initiate a search for a new version of firmware of the electric appliance; and
a server to conduct the search for the new version of firmware in response to the search command signal, and to transmit the new version of the firmware to the electric appliance if the new version of the firmware is located by the search.

11. The firmware upgrade system according to claim 10, wherein the electric appliance comprises:
a runner to execute a management program to upgrade the firmware of the electric appliance; and
a controller to generate the search command signal responsive to the management program and to transmit detailed information of the firmware to the server with the search command signal.

12. The firmware upgrade system according to claim 11, wherein the electric appliance further comprises:
a receiver to receive the new version of firmware from the server;
a storage unit to store the received firmware; and
a recorder to record the stored firmware on a recording medium.

13. The firmware upgrade system according to claim 12, wherein the electric appliance further comprises:
an user interface to display a confirmation message indicating that the new version of electric appliance firmware is received.

14. The firmware upgrade system according to claim 13, wherein the electric appliance further comprises:
a checker to determine whether the recording medium having the new version of firmware recorded thereon is provided to the electric appliance,
wherein the controller, if the recording medium is provided, compares the new version of firmware recorded on the recording medium with firmware stored in firmware storage of the electric appliance, and upgrades the firmware in the firmware storage to the new version of firmware when the new version of firmware is of a more recent version level than the firmware in the firmware storage.

15. A control method of a firmware upgrade system comprising:
generating at a first location while unattended by a user thereat a search command signal to initiate a search for a new version of electric appliance firmware;
transmitting the search command signal from the first location while unattended by the user thereat to a second location at which to perform the search;
performing the search at the second location to determine whether the new version of electric appliance firmware is located thereat in response to the search command signal; and
transmitting the new version of electric appliance firmware to the first location the new version of electric appliance firmware is located by the search at the second location.

16. The control method according to claim 15, further comprising:
receiving the new version of the electric appliance firmware at the first location;
storing the new version of electric appliance firmware; and
recording the stored electric appliance firmware on a recording medium.

17. The control method according to claim 16, further comprising:
reading the recording medium to upgrade electric appliance firmware stored in firmware storage of an electric appliance to the new version of electric appliance firmware.

18. The control method according to claim 15, further comprising:
displaying a confirmation message indicating that the new version of electric appliance firmware is received at the first location.

19. The control method according to claim 16, wherein the recording of the stored electric appliance firmware further comprises:
determining whether the recording medium has been provided in a recorder; and
displaying a selection message to determine whether to record the new version of electric appliance firmware on the recording medium.

20. The control method according to claim 16, wherein the recording of the stored electric appliance firmware further comprises:
creating a directory on the recording medium in which to record the stored firmware; and
recording the new version of electric appliance firmware in the created directory.

21. The control method according to claim 17, further comprising:
comparing the new version of electric appliance firmware recorded on the recording medium with the electric appliance firmware stored in the firmware storage; and
displaying a selection message to determine whether to upgrade to the new version of electric appliance firmware when the new version of electric appliance firmware is newer than the electric appliance firmware in the firmware storage.

22. The control method according to claim 17, wherein the reading the recording medium further comprises:
reading the recording medium in an electric appliance separate and distinct from a user terminal at the first location at which the new version of the electric appliance firmware was recorded on the recording medium.

23. A system to upgrade firmware code of an electric appliance, the system comprising:
a firmware storage unit to store the firmware code therein;
an upgrade controller to generate a search signal in response to other than activation thereof by a user to initiate a search for a new version of the firmware code;
a locator to locate the new version of the firmware code in response to the search signal; and
a controller to replace the firmware code in the firmware storage unit with the new version of the firmware code located by the locator.

24. The system according to claim 23, wherein the controller replaces the firmware code in the firmware storage unit with the new version of the firmware code located by the locator only upon a positive determination that the new firmware code located by the locator is more recent than the firmware code in the firmware storage unit.

25. The system according to claim 23, further comprising:
a runner to generate a signal according to a maintenance schedule whereby, in response thereto, the upgrade controller generates the search signal.

26. The system according to claim 23, further comprising:
a recorder to encode the new version of the firmware code located by the locator in a directory on a portable recording medium; and
a decoder to decode the new version of the firmware code from the portable recording medium.

27. The system according to claim 26, wherein the recorder is located at a user terminal separate and distinct from an electric appliance at which the decoder is located.

28. The system according to claim 26, further comprising:
a storage unit to store the new version of the firmware code located by the locator prior to encoding the new version of the firmware code onto the portable recording medium.

29. The system according to claim 23, further comprising:
a storage unit to store the new version of the firmware code located by the locator, the controller replacing the firmware code in the firmware storage unit with the new version of the firmware code located by the locator stored in the storage unit.

30. The system according to claim 23, wherein the controller and the upgrade controller are collocated in an electric appliance.

31. The system according to claim 23, wherein the firmware storage unit and the controller are located in an electric appliance separate and distinct from a user terminal at which the upgrade controller is located.

32. The system according to claim 23, wherein the locator is located at a server remote from the controller and the upgrade controller.

33. A method of upgrading firmware code of an electric appliance, the method comprising:
locating a new version of the firmware code in response to a search signal generated by other than user activation thereof; and
replacing the firmware code in a firmware storage unit with the located new version of the firmware code.
